(19) United States
(12) Patent Application Publication
(10) Pub. No.: US 2021/0150745 A1
(43) Pub. Date: May 20, 2021

(54) IMAGE PROCESSING METHOD, DEVICE, ELECTRONIC APPARATUS, AND COMPUTER READABLE STORAGE MEDIUM

(71) Applicant: BEIJING SENSETIME TECHNOLOGY DEVELOPMENT CO., LTD, Beijing (CN)

(72) Inventors: Wukui YANG, Beijing (CN); Liwei WU, Beijing (CN)

(21) Appl. No.: 17/048,823

(22) PCT Filed: Sep. 23, 2019
(86) PCT No.: PCT/CN2019/107362

§ 371 Date: Oct. 19, 2020

(30) Foreign Application Priority Data
Dec. 29, 2018 (CN) 201811647485.8

(51) Int. Cl. G06T 7/593; G06T 7/11; G06T 7/246; G06T 7/269; G06K 9/00

(52) U.S. Cl. CPC G06T 7/593; G06T 7/11; G06T 7/248; G06T 7/269; G06K 9/00906; G06K 2209/21; G06T 2207/10048; G06T 2207/10012; G06T 2207/30201; G06K 9/00228; G06T 2207/20084

(57) ABSTRACT

An image processing method, a device, an electronic apparatus, and a storage medium. The method comprises: acquiring a first target region image of a target object and a second target region image of the target object (101); processing the first target region image and the second target region image, and determining parallax between the first target region image and the second target region image (102); and obtaining, on the basis of displacement information between the first target region image and the second target region image and the parallax therebetween, a parallax prediction result between a first image and a second image (103). The method reduces the amount of computation for parallax prediction, thereby achieving faster parallax prediction.

### CROSS-REFERENCE TO RELATED APPLICATIONS

This application is based on, and claims benefit of Chinese Application No. 201811647485.8 filed on Dec. 29, 2018. Disclosure of the Chinese Application is hereby incorporated by reference in its entirety.

### TECHNICAL FIELD

The subject disclosure relates to the field of image processing, and more particularly, to a method and device for processing an image, electronic equipment, and a computer-readable storage medium.

### BACKGROUND

A disparity is a difference in direction of an object as seen from two different locations. For example, one may hold up a finger in front of oneself; close one's right eye to look at the finger with one's left eye; and then close the left eye to look at the finger with the right eye. One may find that there is a change in the location of the finger with respect to a remote object. This is referred to as a disparity of a point as seen from different perspectives.

A disparity between two images collected by a binocular camera may be used to estimate a depth effectively, and may be applied widely to various fields such as liveness detection, authentication, and smart driving. A disparity between two images collected by a binocular camera may be predicted using binocular matching algorithm. With an existing binocular matching algorithm, a disparity between two images may generally be acquired by matching all pixels in the two images, which has a relatively large amount of computation, and relatively low matching efficiency.

### SUMMARY

Embodiments herein provide a technical solution for image processing.

According to a first aspect herein, a method for processing an image includes: acquiring a first target area image of a target object and a second target area image of the target object, the first target area image being cut from a first image collected by a first image sensor of a binocular camera, the second target area image being cut from a second image collected by a second image sensor of the binocular camera; determining a disparity between the first target area image and the second target area image by processing the first target area image and the second target area image; and acquiring a prediction result of a disparity between the first image and the second image based on information on a displacement between the first target area image and the second target area image, as well as the disparity between the first target area image and the second target area image.

According to one or more embodiments herein, acquiring the first target area image of the target object and the second target area image of the target object may include: acquiring the first image collected by the first image sensor of the binocular camera and the second image collected by the second image sensor of the binocular camera; and acquiring the first target area image and the second target area image by performing target detection respectively on the first image and the second image.

According to one or more embodiments herein, acquiring the first target area image of the target object may include: acquiring a first candidate area by performing target detection on the first image collected by the first image sensor of the binocular camera; acquiring key point information by performing key point detection on an image of the first candidate area; and cutting the first target area image from the first image according to the key point information.

According to one or more embodiments herein, the first target area image and the second target area image may be identical in size.

According to one or more embodiments herein, determining the disparity between the first target area image and the second target area image by processing the first target area image and the second target area image may include: acquiring the disparity between the first target area image and the second target area image by processing the first target area image and the second target area image using a binocular matching neural network.

According to one or more embodiments herein, the method may further include: before acquiring the prediction result of the disparity between the first image and the second image based on the information on the displacement between the first target area image and the second target area image as well as the disparity between the first target area image and the second target area image, determining the information on the displacement between the first target area image and the second target area image based on a location of the first target area image in the first image and a location of the second target area image in the second image.

According to one or more embodiments herein, acquiring the prediction result of the disparity between the first image and the second image based on the information on the displacement between the first target area image and the second target area image as well as the disparity between the first target area image and the second target area image may include: acquiring the prediction result of the disparity between the first image and the second image as a sum of the disparity between the first target area image and the second target area image and the information on the displacement between the first target area image and the second target area image.

According to one or more embodiments herein, the method may further include: determining depth information of the target object based on the prediction result of the disparity between the first image and the second image; and determining whether the target object is alive based on the depth information of the target object.

According to one or more embodiments herein, the binocular camera may include a co-modal binocular camera or a cross-modal binocular camera.

According to one or more embodiments herein, the first image sensor or the second image sensor may include a visible light image sensor, a near infrared image sensor, or a dual-channel image sensor.

According to one or more embodiments herein, the target object may include a face.

According to a second aspect herein, a method for processing an image includes: acquiring a first target area image of a target object and a second target area image of the target object, the first target area image being cut from a first image of an image collection area collected at a first time point, the second target area image being cut from a second image of the image collection area collected at a second time point; determining information on an optical flow between the first target area image and the second target area image by processing the first target area image and the second target area image; and acquiring an optical flow prediction result between the first image and the second image based on information on a displacement between the first target area image and the second target area image, as well as the information on the optical flow between the first target area image and the second target area image.

According to one or more embodiments herein, acquiring the first target area image of the target object and the second target area image of the target object may include: acquiring the first image of the image collection area collected at the first time point and the second image of the image collection area collected at the second time point; and acquiring the first target area image and the second target area image by performing target detection respectively on the first image and the second image.

According to one or more embodiments herein, acquiring the first target area image of the target object may include: acquiring a first candidate area by performing target detection on the first image of the image collection area collected at the first time point; acquiring key point information by performing key point detection on an image of the first candidate area; and cutting the first target area image from the first image according to the key point information.

According to one or more embodiments herein, the first target area image and the second target area image may be identical in size.

According to one or more embodiments herein, determining the information on the optical flow between the first target area image and the second target area image by processing the first target area image and the second target area image may include: acquiring the information on the optical flow between the first target area image and the second target area image by processing the first target area image and the second target area image using a neural network.

According to one or more embodiments herein, the method may further include: before acquiring the optical flow prediction result between the first image and the second image based on the information on the displacement between the first target area image and the second target area image, as well as the information on the optical flow between the first target area image and the second target area image, determining the information on the displacement between the first target area image and the second target area image based on a location of the first target area image in the first image and a location of the second target area image in the second image.

According to one or more embodiments herein, acquiring the optical flow prediction result between the first image and the second image based on the information on the displacement between the first target area image and the second target area image, as well as the information on the optical flow between the first target area image and the second target area image may include: acquiring the optical flow prediction result between the first image and the second image as a sum of the information on the optical flow between the first target area image and the second target area image and the information on the displacement between the first target area image and the second target area image.

According to a third aspect herein, a method for processing an image may include: acquiring a first target area image cut from a first image and a second target area image cut from a second image; acquiring a relative processing result of the first image and the second image by processing the first target area image and the second target area image; and acquiring a final processing result of the first image and the second image based on information on a displacement between the first target area image and the second target area image, as well as the relative processing result of the first image and the second image.

According to one or more embodiments herein, the first image and the second image may be images collected by two image sensors of a binocular camera at a same time point.

According to one or more embodiments herein, the relative processing result may be a relative disparity. The final processing result may be a prediction result of a disparity.

According to one or more embodiments herein, the prediction result of the disparity may be acquired referring to the method according to the first aspect or any possible implementation of the first aspect.

According to one or more embodiments herein, the first image and the second image may be images of one target area collected by a camera at different time points.

According to one or more embodiments herein, the relative processing result may be a relative optical flow. The final processing result may be a prediction result of an optical flow.

According to one or more embodiments herein, the prediction result of the optical flow may be acquired referring to the method according to the second aspect or any possible implementation of the second aspect.

According to a fourth aspect herein, a device for processing an image includes an acquiring unit, a first determining unit, and a second determining unit. The acquiring unit may be adapted to acquiring a first target area image of a target object and a second target area image of the target object. The first target area image is cut from a first image collected by a first image sensor of a binocular camera. The second target area image is cut from a second image collected by a second image sensor of the binocular camera. The first determining unit may be adapted to determining a disparity between the first target area image and the second target area image by processing the first target area image and the second target area image. The second determining unit may be adapted to acquiring a prediction result of a disparity between the first image and the second image based on information on a displacement between the first target area image and the second target area image, as well as the disparity between the first target area image and the second target area image.

According to one or more embodiments herein, the acquiring unit may be adapted to acquiring the first image collected by the first image sensor of the binocular camera and the second image collected by the second image sensor of the binocular camera; acquiring the first target area image and the second target area image by performing target detection respectively on the first image and the second image.

According to one or more embodiments herein, the acquiring unit may include a target detecting unit, a key point detecting unit, and a cutting unit. The target detecting unit may be adapted to acquiring a first candidate area by performing target detection on the first image collected by the first image sensor of the binocular camera. The key point detecting unit may be adapted to acquiring key point information by performing key point detection on an image of the first candidate area. The cutting unit may be adapted to cutting the first target area image from the first image according to the key point information.

According to one or more embodiments herein, the first target area image and the second target area image may be identical in size.

According to one or more embodiments herein, the first determining unit may be adapted to acquiring the disparity between the first target area image and the second target area image by processing the first target area image and the second target area image using a binocular matching neural network.

According to one or more embodiments herein, the device may further include a displacement determining unit. The displacement determining unit may be adapted to, before the second determining unit acquires the prediction result of the disparity between the first image and the second image based on the information on the displacement between the first target area image and the second target area image, as well as the disparity between the first target area image and the second target area image, determining the information on the displacement between the first target area image and the second target area image based on a location of the first target area image in the first image and a location of the second target area image in the second image.

According to one or more embodiments herein, the second determining unit may be adapted to acquiring the prediction result of the disparity between the first image and the second image as a sum of the disparity between the first target area image and the second target area image and the information on the displacement between the first target area image and the second target area image.

According to one or more embodiments herein, the device may further include a depth determining unit and a liveness detecting unit. The depth determining unit may be adapted to determining depth information of the target object based on the prediction result of the disparity between the first image and the second image. The liveness detecting unit may be adapted to determining whether the target object is alive based on the depth information of the target object.

According to one or more embodiments herein, the binocular camera may include a co-modal binocular camera or a cross-modal binocular camera.

According to one or more embodiments herein, the first image sensor or the second image sensor may include a visible light image sensor, a near infrared image sensor, or a dual-channel image sensor.

According to one or more embodiments herein, the target object may include a face.

According to a fifth aspect herein, a device for processing an image includes an acquiring unit, a first determining unit, and a second determining unit. The acquiring unit may be adapted to acquiring a first target area image of a target object and a second target area image of the target object. The first target area image is cut from a first image of an image collection area collected at a first time point. The second target area image is cut from a second image of the image collection area collected at a second time point. The first determining unit may be adapted to determining information on an optical flow between the first target area image and the second target area image by processing the first target area image and the second target area image. The second determining unit may be adapted to acquiring an optical flow prediction result between the first image and the second image based on information on a displacement between the first target area image and the second target area image, as well as the information on the optical flow between the first target area image and the second target area image.

According to one or more embodiments herein, the acquiring unit may be adapted to acquiring the first image of the image collection area collected at the first time point and the second image of the image collection area collected at the second time point; acquiring the first target area image and the second target area image by performing target detection respectively on the first image and the second image.

According to one or more embodiments herein, the acquiring unit may include a target detecting unit, a key point detecting unit, and a cutting unit. The target detecting unit may be adapted to acquiring a first candidate area by performing target detection on the first image of the image collection area collected at the first time point. The key point detecting unit may be adapted to acquiring key point information by performing key point detection on an image of the first candidate area. The cutting unit may be adapted to cutting the first target area image from the first image according to the key point information.

According to one or more embodiments herein, the first target area image and the second target area image may be identical in size.

According to one or more embodiments herein, the first determining unit may be adapted to acquiring the information on the optical flow between the first target area image and the second target area image by processing the first target area image and the second target area image using a neural network.

According to one or more embodiments herein, the device may further include a displacement determining unit. The displacement determining unit may be adapted to, before the second determining unit acquires the optical flow prediction result between the first image and the second image based on the information on the displacement between the first target area image and the second target area image, as well as the information on the optical flow between the first target area image and the second target area image, determining the information on the displacement between the first target area image and the second target area image based on a location of the first target area image in the first image and a location of the second target area image in the second image.

According to one or more embodiments herein, the second determining unit may be adapted to acquiring the optical flow prediction result between the first image and the second image as a sum of the information on the optical flow between the first target area image and the second target area image and the information on the displacement between the first target area image and the second target area image.

According to a fifth aspect herein, electronic equipment includes a processor and memory. The memory is adapted to storing a computer-readable instruction. The processor is adapted to implementing, by calling the computer-readable instruction stored in the memory, the method according to the first aspect or the second aspect herein, or any possible implementation thereof.

According to a sixth aspect herein, a computer-readable storage medium has stored therein computer program instructions which, when executed by a processor, implement the method according to the first aspect or the second aspect herein, or any possible implementation thereof.

According to a seventh aspect herein, a computer program product includes computer instructions which, when executed by a processor, implement the method according to the first aspect or the second aspect herein, or any possible implementation thereof.

According to one or more embodiments herein, the computer program product may include a computer-readable storage medium storing the computer instructions.

With embodiments herein, a first target area image of a target object and a second target area image of the target object are acquired. A disparity between the first target area image and the second target area image is determined by processing the first target area image and the second target area image. A prediction result of the disparity between the first image and the second image is acquired based on information on a displacement between the first target area image and the second target area image, as well as the disparity between the first target area image and the second target area image. With embodiments herein, an amount of computation for predicting a disparity is reduced, thereby increasing a prediction speed of the disparity, and facilitating real-time disparity prediction.

Other characteristics and aspects herein may become clear according to detailed description of exemplary embodiments made below with reference to the drawings.

### BRIEF DESCRIPTION OF THE ACCOMPANYING DRAWINGS

Drawings for describing embodiments herein or related art are introduced below briefly for clearer illustration of a technical solution of embodiments herein. Note that the drawings described below refer merely to some embodiments herein. A person having ordinary skill in the art may acquire other drawings according to the drawings herein without creative effort.

FIG. 1 is a flowchart of a method for processing an image according to an exemplary embodiment herein.

FIG. 2 is a diagram of determining a disparity between a first target area image and a second target area image according to an exemplary embodiment herein.

FIG. 3 is a diagram of a method for determining a displacement of a target area according to an exemplary embodiment herein.

FIG. 4 is a flowchart of a method for processing an image according to an exemplary embodiment herein.

FIG. 5 is a diagram of a structure of a device for processing an image according to an exemplary embodiment herein.

FIG. 6 is a diagram of a structure of a device for processing an image according to an exemplary embodiment herein.

FIG. 7 is a diagram of a structure of a device for processing an image according to an exemplary embodiment herein.

FIG. 8 is a diagram of a structure of a device for processing an image according to an exemplary embodiment herein.

FIG. 9 is a block diagram of a structure of electronic equipment according to an exemplary embodiment herein.

### DETAILED DESCRIPTION

Clear complete description to a technical solution herein is given below with reference to the drawings and embodiments herein. Clearly, embodiments illustrated herein are but some, instead of all, embodiments according to the subject disclosure. Based on the embodiments herein, a person having ordinary skill in the art may acquire another embodiment without creative effort. Any such embodiment falls within the scope of the subject disclosure.

Note that a term such as “including/comprising”, “containing”, etc., used herein indicates existence of characteristics, an ensemble, a step, an operation, an element, a component, etc., as illustrated. However, existence or addition of one or more other characteristics, ensembles, steps, operations, elements, components, etc., and/or a combination thereof is not excluded.

Further note that a term used herein is intended for describing an embodiment instead of limiting the subject disclosure. Singulars “a/an”, “said” and “the” used in the subject disclosure and the appended claims are intended to include the plural form, unless expressly illustrated otherwise by context.

Further note that t a term “and/or” herein may refer to any combination, as well as all possible combinations, of one or more of associated items listed, including these combinations.

As used herein, depending on a context, a term “if” may be explained as “when”, “once”, “in response to determining that”, “in response to detecting that”, etc. Similarly, depending on a context, a phrase “if [a described condition or event] is detected/determined” may be explained as “once [a described condition or event] is detected/determined”, “in response to detecting/determining [a described condition or event]”, etc.

A method for processing an image herein may be implemented by electronic equipment or a system such as terminal equipment, a server, etc., that is capable of processing an image, such as a mobile phone, a desktop computer, a laptop, wearable equipment, etc., which is not limited herein. For easy understanding, an entity that executes a method for processing an image may be referred to as a device for processing an image hereinafter.

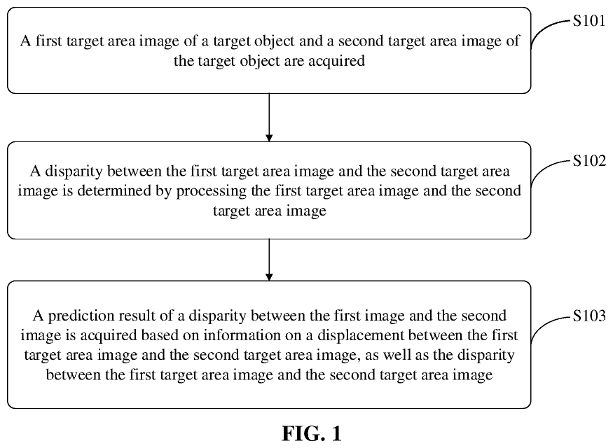

FIG. 1 is a flowchart of a method for processing an image according to an exemplary embodiment herein.

In S101, a first target area image of a target object and a second target area image of the target object may be acquired.

According to one or more embodiments herein, two image sensors in a binocular camera may be referred to as a first image sensor and a second image sensor. Two image sensors of a binocular camera may be arranged horizontally or vertically, which is not limited herein. As an example, the first image sensor and the second image sensor each may be a device with a photographing function, such as a camera.

According to one or more embodiments herein, the first image sensor or the second image sensor may include a visible light image sensor, a near infrared image sensor, or a dual-channel image sensor. The first image sensor or the second image sensor herein may be an image sensor of another type. The type of an image sensor is not limited herein.

A visible light image sensor may generate an image by irradiating an object using visible light. A near infrared image sensor may generate an image by irradiating an object using near infrared light. A dual-channel image sensor may generate an image using two channels (including an R channel). Two image sensors in a binocular camera may be of a same type. Two image sensors in a binocular camera may be of different types. That is, a binocular camera may be a co-modal binocular camera or a cross-modal binocular camera. For example, the two image sensors of a binocular camera A may be visible light image sensors. The two image sensors of a binocular camera B may be near infrared image sensors. The two image sensors of a binocular camera C may be dual-channel image sensors. The two image sensors of a binocular camera D may be a visible light image sensor and a near infrared image sensor, respectively. The two image sensors of a binocular camera E may be a visible light image sensor and a dual-channel image sensor, respectively. The two image sensors of a binocular camera F may be a near infrared image sensor and a dual-channel image sensor, respectively, etc. The type of either image sensor in a binocular camera may be selected as needed, extending a range applicable thereto, increasing scalability thereof.

A technical solution herein is applicable to a field such as target identification, liveness detection, smart transportation, etc. A target object may differ depending on a field of application. In target identification, a target object may be a specific object such as a human body, a face, a mask, an ear, clothes, etc. In liveness detection, a target object may be one of various living objects or part of a living object, such as a person, an animal, a face, etc. In the field of clothes identification, a target object may be various types of clothes such as headwear, a top, a bottom, a jumpsuit, etc. In smart transportation, a target object may be a road, a building, a pedestrian, a traffic light, a vehicle, a designate part of a vehicle, etc. For example, the target object may be a bicycle, a car, a bus, a truck, the front of a vehicle, the rear of a vehicle, etc. Implementation of a target object is not limited herein.

According to one or more embodiments herein, a target object may be a face. Accordingly, both the first target area and the second target area may include a face. Of course, a target object herein is not limited to a face, but may be another object.

According to one or more embodiments herein, a first image may be collected by a first image sensor of a binocular camera. A second image may be collected by a second image sensor of the binocular camera. According to one or more embodiments herein, the first image and the second image may be a left view and a right view, respectively. Alternatively, the first image and the second image may be a right view and a left view, respectively, which is not limited herein.

According to one or more embodiments herein, a first target area image of a target object and a second target area image of the target object may be acquired as follows. The first image collected by the first image sensor of the binocular camera and the second image collected by the second image sensor of the binocular camera may be acquired. The first target area image of the target object may be cut from the first image. The second target area image of the target object may be cut from the second image.

According to one or more embodiments herein, a binocular camera may collect a pair of static images including a first image and a second image. Alternatively, a binocular camera may collect a continuous video stream. A pair of images including a first image and a second image may be acquired by performing frame selection on the video stream. Accordingly, a first image and a second image may be static images acquired from a pair of static image, or video images acquired from a video stream, which is not limited herein.

According to one or more embodiments herein, a device for processing an image may be provided with a binocular camera. The device for processing an image may acquire a pair of images including a first image and a second image by collecting a pair of static images or a video stream using the binocular camera, which is not limited herein.

According to one or more embodiments herein, a device for processing an image may receive a pair of images including a first image and a second image from other equipment. For example, a device for processing an image may receive a pair of images including a first image and a second image from a database provided at other equipment. A pair of images including a first image and a second image may be sent in a message such as a liveness detecting request, an authenticating request, a depth predicting request, a binocular matching request, etc. Then, the device for processing an image may cut a first target area image and a second target area image from the first image and the second image, respectively, which is not limited herein. As another example, a device for processing an image may receive a pair of images including a first image and a second image from terminal equipment provided with a binocular camera. Optionally, terminal equipment may send a pair of images including a first image and a second image to the device for processing an image (such as a server). A pair of images including a first image and a second image may be a pair of static images collected by terminal equipment using a binocular camera, or a pair of video images selected from images of a video stream collected by the binocular camera. As another example, terminal equipment may send a video sequence including the pair of images to the device for processing an image. After receiving the video stream sent by the terminal equipment, the device for processing an image may select a pair of images including a first image and a second image from the video stream, which is not limited herein.

According to one or more embodiments herein, a pair of images including a first image and a second image may be acquired by performing frame selection on a video stream in manners as follows.

According to one or more embodiments herein, the first image may be acquired by performing frame selection on a video stream or a video sequence collected by the first image sensor, and a video stream or a video sequence collected by the second image sensor may be searched for the second image corresponding to the first image, and thus a pair of images including the first image and the second image may be acquired. According to one or more embodiments herein, a first image may be selected from multiple images included in a first video stream collected by the first image sensor based on quality of an image. Quality of an image may depend on a factor such as the definition of the image, brightness of the image, the exposure of the image, the contrast of the image, completeness of the face, whether view of the face is blocked, etc., or any combination thereof. That is, a first image may be selected from multiple images included in a first video stream collected by the first image sensor based on quality of an image based on one or any combination of the following factors: the definition of the image, brightness of the image, the exposure of the image, the contrast of the image, completeness of the face, whether view of the face is blocked, etc.

According to one or more embodiments herein, a first image may be acquired by performing frame selection on a video stream based on a face status of a target object in an image and the quality of the image. For example, the face status of the target object in each image or in a number of images with an interval of several images in the first video stream may be determined based on key point information acquired by performing key point detection. A face status may be the orientation of the face, for example. Quality of each image or a number of images with an interval of several images in the first video stream may be determined. Combining the face status of the target object in an image and the quality of the image, one or more images of high quality, with the face status of the images meeting a preset condition (such as where the target object is facing straight ahead, or is facing a direction at an angle less than a set threshold to the front direction), may be selected as the first image. According to one or more embodiments herein, a first image may be selected from images based on the status of the target object in the images. Optionally, a status of a target object may include a factor such as whether the target object is facing straight ahead, whether the target object's eyes are closed, whether the target object's mouth is open, whether the target object is blurred or out of focus due to movement, etc., or a combination of the factors, which is not limited herein.

According to one or more embodiments herein, a pair of images including a first image and a second image may be selected jointly from images of a first video stream collected by the first image and a second video stream collected by the second image sensor. In such a case, the pair of images selected from the video streams collected by the binocular camera may meet a set condition. Implementation of the set condition is as described above, which is not repeated here for simplicity.

According to one or more embodiments herein, before performing binocular matching on the first image and the second image (such as cutting the first target area image from the first image and cutting the second target area image from the second image), correction processing may be performed on the first image and the second image, so as to align a pixel in the first image and a pixel in the second image corresponding to the pixel in the first image on one horizontal line. According to one or more embodiments herein, binocular correction may be performed on the first image and the second image based on a parameter of the binocular camera acquired by calibration. For example, binocular correction may be performed on the first image and the second image based on a parameter of the first image sensor, a parameter of the second image sensor, a relative location parameter of the first image sensor and the second image sensor. According to one or more embodiments herein, the first image and the second image may be corrected automatically without relying on a parameter of the binocular camera. For example, key point information (referred to as first key point information, or, information on a first key point) of the target object in the first image and key point information (referred to as second key point information, or, information on a second key point) of the target object in the second image may be acquired. A target transformation matrix may be determined based on the information on the first key point and the information on the second key point (such as by using least squares). Then, a transformed first image or a transformed second image may be acquired by transforming the first image or the second image based on the target transformation matrix, which however is not limited herein.

According to one or more embodiments herein, a pixel in the first image and a pixel in the second image corresponding to the pixel in the first image may be located on one horizontal line. For example, at least one of the first image or the second image may be pre-processed, such as translated and/or rotated, based on a parameter of the first image sensor and a parameter of the second image sensor, so as to align, on one horizontal line, a pixel in the first image pre-processed and a pixel in the second image pre-processed corresponding to the pixel in the first image pre-processed. As another example, the two image sensors in the binocular camera may not be calibrated. In such a case, matching detection and correction processing may be performed on the first image and the second image, so as to align, on one horizontal line, a pixel in the first image corrected and a pixel in the second image corrected corresponding to the pixel in the first image corrected, which is not limited herein.

According to one or more embodiments herein, the two image sensors of the binocular camera may be calibrated in advance to acquire a parameter of the first image sensor and a parameter of the second image sensor.

According to one or more embodiments herein, a first target area image of a target object and a second target area image of the target object may be acquired in manners as follows.

According to one or more embodiments herein, a device for processing an image may acquire a first target area image and a second target area image directly from other equipment. The first target area image and the second target area image may be cut from a first image and a second image, respectively. The first target area image and the second target area image may be sent in a message such as a liveness detecting request, an authenticating request, a depth predicting request, a binocular matching request, etc., which is not limited herein. For example, the device for processing an image may acquire the first target area image and the second target area image from a database provided at other equipment. As another example, the device for processing an image (such as a server) may receive the first target area image and the second target area image sent by terminal equipment provided with a binocular camera. Optionally, the terminal equipment may collect a pair of static images including the first image and the second image using the binocular camera, and cut the first target area image and the second target area image respectively from the first image and the second image. Alternatively, the terminal equipment may collect a video sequence using the binocular camera, and select a pair of video images including the first image and the second image from images of the video sequence. As another example, the terminal equipment may send a video stream including a pair of images including the first image and the second image to the device for processing an image. The first target area image and the second target area image may be cut respectively from the first image and the second image, which is not limited herein.

According to one or more embodiments herein, a first target area image of a target object and a second target area image of the target object may be acquired as follows. The first image collected by the first image sensor of the binocular camera and the second image collected by the second image sensor of the binocular camera may be acquired. The first target area image and the second target area image may be acquired by performing target detection respectively on the first image and the second image.

According to one or more embodiments herein, information on a first location of the target object in the first image and information on a second location of the target object in the second image may be acquired respectively by performing target detection respectively on the first image and the second image. The first target area image may be cut from the first image based on the information on the first location. The second target area image may be cut from the second image based on the information on the second location.

Optionally, the target object may be detected directly from the first image and the second image. Alternatively, the first image and/or the second image may be pre-processed. Then, the target object may be detected respectively from the first image pre-processed and/or the second image pre-processed. An image may be pre-processed by at least one of brightness adjustment, size adjustment, translation, rotation, etc., which is not limited herein.

According to one or more embodiments herein, the first target area image of the target object may be acquired as follows. A first candidate area may be acquired by performing target detection on the first image collected by the first image sensor of the binocular camera. Information on a key point may be acquired by performing key point detection on an image of the first candidate area. The first target area image may be cut from the first image according to the key point information.

According to one or more embodiments herein, a first candidate area in a first image and a second candidate area in a second image corresponding to the first candidate area may be acquired by performing target detection respectively on the first image and the second image. A first target area image may be cut from the first image based on the first candidate area. A second target area image may be cut from the second image based on the second candidate area.

For example, an image of a first candidate area may be cut from a first image as a first target area image. As another example, a first target area may be acquired by zooming in on a first candidate area by a factor. A first target area image may be cut from the first image.

According to one or more embodiments herein, information on a first key point corresponding to a first candidate area may be acquired by detecting the first key point in an image of the first candidate area. A first target area image may be cut from a first image based on the information on the first key point. Likewise, information on a second key point corresponding to a second candidate area may be acquired by detecting the second key point in an image of the second candidate area. A second target area image may be cut from a second image based on the information on the second key point.

According to one or more embodiments herein, the first candidate area containing the target object may be acquired by performing target detection on the first image through image processing technologies (such as a convolutional neural network). Likewise, the second candidate area containing the target object may be acquired by performing target detection on the second image through image processing technologies (such as a convolutional neural network). The first candidate area and the second candidate area may be a first face area, for example. A target object may be detected by determining the approximate location of the target object. Accordingly, the first candidate area may be a preliminary area including the target object. The second candidate area may be a preliminary area including the target object.

A key point may be detected using a deep neural network such as a convolutional neural network, a recurrent neural network, etc., such as a neural network model of any type such as LeNet, AlexNet, GoogLeNet, VGGNet, ResNet, etc. Alternatively, a key point may be detected based on another machine learning method. The manner of key point detection is not limited herein.

Information on a key point may include information on the location of each of multiple key points of the target object. Information on a key point may further include information such as a confidence, etc., which is not limited herein.

For example, the target object may be a face. Then, information on multiple key points of a face in an image of a first candidate area and information on multiple key points of a face in an image of a second candidate area may be acquired by detecting, using a model for detecting a key point of a face, the key points of the face in the image of the first candidate area and the key points of the face in in the image of the second candidate area respectively. Information on the location of the face may be determined based on the information on the multiple key points. A first target area containing the face and a second target area containing the face may be determined based on the information on the location of the face. Compared to the first candidate area and the second candidate area, the first target area and the second target area may indicate a more accurate location of the face. Thus, a subsequent operation may be performed more accurately.

According to one or more embodiments herein, when performing target detection on the first image and the second image, no accurate location of the target object or an area containing the target object has to be determined. Instead, it is enough to determine a rough location of the target object or the area containing the target object, thereby lowering a requirement on precision of a target detecting algorithm, improving robustness as well as a processing speed of an image.

According to one or more embodiments herein, the second target area image and the first target area image may be cut in one manner or in different manners, which is not limited herein.

According to one or more embodiments herein, optionally, the first target area image and the second target area image may differ in size. Alternatively, the first target area image and the second target area image may be identical in size, simplifying computation, improving a processing speed.

According to one or more embodiments herein, the first target area image and the second target area image may be made to have the same size by cutting the first target area image and the second target area image respectively from the first image and the second image using cutting parameters representing cutting boxes of the same size. For example, according to one or more embodiments herein, two cutting boxes of the same size, each enclosing the entire target object, may be acquired based on information on the first location and information on the second location of the target object. As another example, according to one or more embodiments herein, the target object may be detected respectively in the first image and the second image so as to acquire a first cutting box (corresponding to the first image) and a second cutting box (corresponding to the second image of the same size. As another example, according to one or more embodiments herein, if the first cutting box and the second cutting box differ in size, the first cutting box and the second cutting box may be enlarged by different factors. That is, a first cutting parameter corresponding to the first cutting box and a second cutting parameter corresponding to the second cutting box may be enlarged respectively by different factors, such that the two enlarged cutting boxes have the same size. As another example, according to one or more embodiments herein, a first target area and a second target area of the same size may be determined according to key point information in a first image and key point information in a second image. The first target area and the second target area each enclose an entire target object, etc.

According to one or more embodiments herein, by performing target detection on a first image and a second image, information irrelevant to the target object or a target area may be removed. Accordingly, a size of an image to be input to a binocular matching algorithm, as well as an amount of data to be processed, may be reduced. An inter-image disparity may be predicted at an increased speed. According to one or more embodiments herein, in liveness detection, depth information of an image may be acquired by predicting an inter-image disparity, thereby determining whether a face in the image is alive. Accordingly, it is enough to consider an area of an image containing a face. Therefore, it may suffice to predict a disparity between face-containing areas of two images, avoiding unnecessary computation, increasing a prediction speed of a disparity.

In S102, a disparity between the first target area image and the second target area image is determined by processing the first target area image and the second target area image.

According to one or more embodiments herein, in S102, the disparity between the first target area image and the second target area image may be determined by processing the first target area image and the second target area image as follows. The disparity between the first target area image and the second target area image may be acquired by processing the first target area image and the second target area image using a binocular matching neural network.

According to one or more embodiments herein, the disparity between the first target area image and the second target area image may be acquired by processing the first target area image and the second target area image using a binocular matching neural network. Then, the disparity between the first target area image and the second target area image may be output by the binocular matching neural network.

According to one or more embodiments herein, the first target area image and the second target area image may be input directly to and processed by the binocular matching neural network, acquiring the disparity between the first target area image and the second target area image. According to one or more embodiments herein, the first target area image and/or the second target area image may be pre-processed, such as by being rotated to face straight ahead, etc. Then, the first target area image and the second target area image pre-processed may be input to and processed by the binocular matching neural network, acquiring the disparity between the first target area image and the second target area image, which is not limited herein.

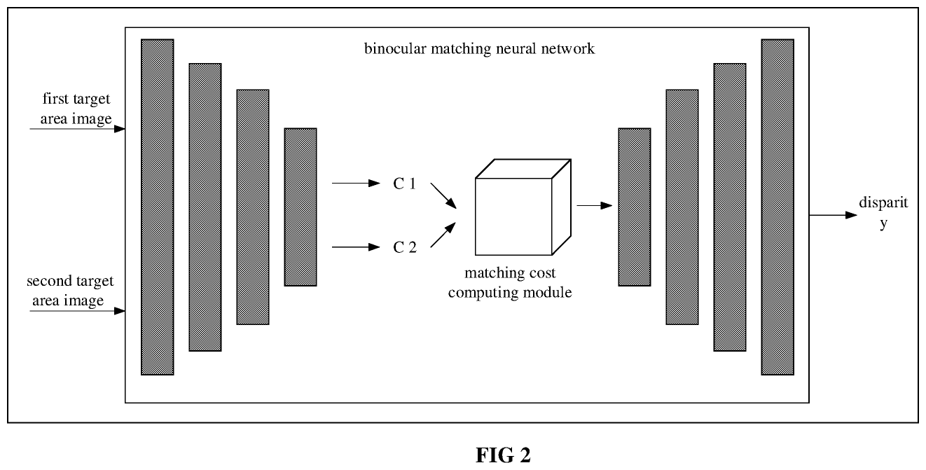

FIG. 2 is a diagram of determining a disparity between a first target area image and a second target area image according to an exemplary embodiment herein. Referring to FIG. 2, the first target area image and the second target area image may be input to the binocular matching neural network. First characteristics (C1 in FIG. 2) of the first target area image and second characteristics (C2 in FIG. 2) of the second target area image may be extracted respectively using the binocular matching neural network. A matching cost of matching the first characteristics and the second characteristics may be computed by a matching cost computing module in the binocular matching neural network. The disparity between the first target area image and the second target area image may be determined based on the matching cost. The matching cost may represent a correlation between the first characteristics and the second characteristics. The disparity between the first target area image and the second target area image may be determined based on the matching cost as follows. Characteristics of the matching cost may be extracted. The disparity between the first target area image and the second target area image may be determined based on extracted characteristics data.

According to one or more embodiments herein, in S102, the disparity between the first target area image and the second target area image may be determined using another machine-learning-based binocular matching algorithm. In application, such a binocular matching algorithm may be any one of a Sum of Absolute Differences (SAD) algorithm, a Bidirectional Matching (BM) algorithm, a Semi-Global Block Matching (SGBM) algorithm, a Graph Cuts (GC) algorithm, etc. Implementation of binocular matching is not limited herein.

In S103, a prediction result of a disparity between the first image and the second image is acquired based on information on a displacement between the first target area image and the second target area image, as well as the disparity between the first target area image and the second target area image.

According to one or more embodiments herein, the method may further include a step as follows. Before a prediction result of a disparity between the first image and the second image is acquired based on information on a displacement between the first target area image and the second target area image, as well as the disparity between the first target area image and the second target area image as in S103, the information on the displacement between the first target area image and the second target area image may be determined based on a location of the first target area image in the first image and a location of the second target area image in the second image. Optionally, the information on the displacement may include a displacement in a horizontal direction and/or a displacement in a vertical direction. According to one or more embodiments herein, a pixel in the first image and a pixel in the second image corresponding to the pixel in the first image may be located on one horizontal line. Then, the information on the displacement may include only a displacement in the horizontal direction, which however is not limited herein.

The information on the displacement between the first target area image and the second target area image may be determined based on a location of the first target area image in the first image and a location of the second target area image in the second image, as follows. A location of a first center point of the first target area image may be determined. A location of a second center point of the second target area image may be determined. The information on the displacement between the first target area image and the second target area image may be determined based on the location of the first center point and the location of the second center point.

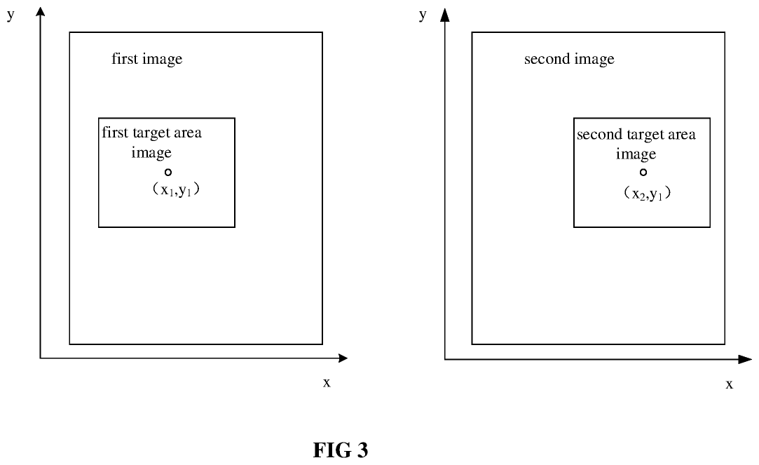

FIG. 3 is a diagram of a method for determining a displacement of a target area according to an exemplary embodiment herein. Referring to FIG. 3, the center point a of the first target area image in the first image may be at a location (x₁, y₁). The center point b of the second target area image in the second image may be at a location (x₂, y₁). The displacement between the center point a and the center point b, i.e., the information on the displacement between the first target area image and the second target area image, may be expressed as \vec{x}=(x₂−x₁, 0). According to one or more embodiments herein, a center point aforementioned may be replaced with any of four vertexes of an image of a target area, which is not limited herein.

According to one or more embodiments herein, the information on the displacement between the first target area image and the second target area image may be determined in another manner, which is not limited herein.

According to one or more embodiments herein, in S103, the prediction result of the disparity between the first image and the second image may be acquired based on the information on the displacement between the first target area image and the second target area image, as well as the disparity between the first target area image and the second target area image, as follows. The prediction result of the disparity between the first image and the second image may be acquired as a sum of the disparity between the first target area image and the second target area image and the information on the displacement between the first target area image and the second target area image.

For example, the information on the displacement between the first target area image and the second target area image may be x. The disparity between the first target area image and the second target area image may be D(p). The prediction result of the disparity between the first image and the second image may be acquired as a sum of, or a difference between, the information on the displacement x and the disparity D(p).

According to one or more embodiments herein, the displacement between the first target area image and the second target area image may be 0. In such a case, the disparity between the first target area image and the second target area image may be the disparity between the first image and the second image.

According to one or more embodiments herein, the information on the displacement and the disparity between the first target area image and the second target area image may be determined concurrently or in any sequence, which is not limited herein.

According to one or more embodiments herein, the method may further include a step as follows. After the prediction result of the disparity between the first image and the second image has been acquired in S103, depth information of the target object may be determined based on the prediction result of the disparity between the first image and the second image. It may be determined whether the target object is alive based on the depth information of the target object.

According to one or more embodiments herein, a first target area image of a target object and a second target area image of the target object may be acquired. A disparity between the first target area image and the second target area image is determined by processing the first target area image and the second target area image. A prediction result of the disparity between the first image and the second image is acquired based on information on a displacement between the first target area image and the second target area image, as well as the disparity between the first target area image and the second target area image. With embodiments herein, an amount of computation for predicting a disparity is reduced, increasing a prediction speed of the disparity, facilitating real-time disparity prediction.

Note that a technical solution herein has been illustrated with an example of predicting a disparity. Optionally, a technical solution herein may be applied to another scene such as of optical flow prediction, etc. In such a case, the first image and the second image may be images collected by a monocular camera at different time points, etc., which is not limited herein.

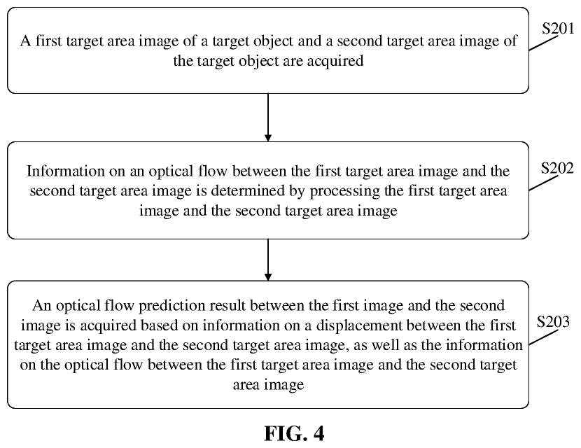

FIG. 4 is a flowchart of a method for processing an image according to an exemplary embodiment herein.

In S201, a first target area image of a target object and a second target area image of the target object are acquired. The first target area image is cut from a first image of an image collection area collected at a first time point. The second target area image is cut from a second image of the image collection area collected at a second time point.

In S202, information on an optical flow between the first target area image and the second target area image is determined by processing the first target area image and the second target area image.

In S203, an optical flow prediction result between the first image and the second image is acquired based on information on a displacement between the first target area image and the second target area image, as well as the information on the optical flow between the first target area image and the second target area image.

According to one or more embodiments herein, an image of an image collection area may be collected using a monocular camera. A first target area image and a second target area image may be acquired based on images collected at different time points. As an example, an image collected at a first time point may be denoted by a first image. The first target area image may be acquired from the first image. An image collected at a second time point may be denoted by a second image. The second target area image may be acquired from the second image.

According to one or more embodiments herein, a first target area image of a target object and a second target area image of the target object may be acquired as follows. The first image of the image collection area collected at the first time point and the second image of the image collection area collected at the second time point may be acquired. The first target area image and the second target area image may be acquired by performing target detection respectively on the first image and the second image.

According to one or more embodiments herein, the first target area image of the target object may be acquired as follows. A first candidate area may be acquired by performing target detection on the first image of the image collection area collected at the first time point. Information on a key point may be acquired by performing key point detection on an image of the first candidate area. The first target area image may be cut from the first image according to the key point information.

According to one or more embodiments herein, optionally, the first target area image and the second target area image may be identical in size.

According to one or more embodiments herein, one may refer to elaboration of S101 according to one or more embodiments herein for description of S201, which is not repeated here.

According to one or more embodiments herein, the information on the optical flow between the first target area image and the second target area image may be determined by processing the first target area image and the second target area image, as follows. The information on the optical flow between the first target area image and the second target area image may be acquired by processing the first target area image and the second target area image using a neural network.

In such a manner, the information on the optical flow between the first target area image and the second target area image may be acquired by processing the first target area image and the second target area image using a neural network.

According to one or more embodiments herein, the first target area image and the image of the second target are may be input to and processed by a neural network to acquire the information on the optical flow between the first target area image and the second target area image. According to one or more embodiments herein, the first target area image and/or the second target area image may be pre-processed, such as by being rotated to face straight ahead, etc. Then, the first target area image and the second target area image pre-processed may be input to a neural network, acquiring information on the optical flow between the first target area image and the second target area image. Locations of the first target area image and the second target area image may vary. Therefore, the information on the optical flow may be a relative concept and may represent information on the relative optical flow of the target object, i.e., relative movement of the target object.

According to one or more embodiments herein, the method may further include a step as follows. Before the optical flow prediction result between the first image and the second image is acquired based on the information on the displacement between the first target area image and the second target area image, as well as the information on the optical flow between the first target area image and the second target area image, the information on the displacement between the first target area image and the second target area image may be determined based on a location of the first target area image in the first image and a location of the second target area image in the second image.

According to one or more embodiments herein, one may refer to description in an aforementioned embodiment for description of determining the information on the displacement between the first target area image and the second target area image, which is not repeated here.

According to one or more embodiments herein, the optical flow prediction result between the first image and the second image may be acquired based on the information on the displacement between the first target area image and the second target area image, as well as the information on the optical flow between the first target area image and the second target area image, as follows. The optical flow prediction result between the first image and the second image may be acquired as a sum of the information on the optical flow between the first target area image and the second target area image and the information on the displacement between the first target area image and the second target area image.

According to one or more embodiments herein, locations of the first target area image and the second target area image may vary. Therefore, the information on the displacement between the first target area image and the second target area image may have to be determined. A optical flow prediction result may be acquired as a sum of, or a difference between, the information on the displacement and the information on the optical flow. The optical flow prediction result may represent information on an absolute optical flow of the target object, i.e., an absolute movement of the target object.

The method for processing an image here may be applied to optical flow information prediction. The method for processing an image according to FIG. 1 may be applied to disparity information prediction. Both methods may be implemented basically with the same technics. For simplicity, one may refer to description of the method for processing an image according to FIG. 1 for implementation of the method for processing an image here, which is not repeated here.

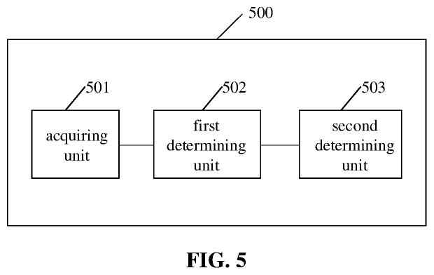

According to one or more embodiments herein, a device for processing an image is further provided. FIG. 5 is a diagram of a structure of a device for processing an image according to an exemplary embodiment herein. The device 500 may include an acquiring unit 501, a first determining unit 502, and a second determining unit 503.

The acquiring unit 501 is adapted to acquiring a first target area image of a target object and a second target area image of the target object. The first target area image is cut from a first image collected by a first image sensor of a binocular camera. The second target area image is cut from a second image collected by a second image sensor of the binocular camera.

The first determining unit 502 is adapted to determining a disparity between the first target area image and the second target area image by processing the first target area image and the second target area image.

The second determining unit 503 is adapted to acquiring a prediction result of a disparity between the first image and the second image based on information on a displacement between the first target area image and the second target area image, as well as the disparity between the first target area image and the second target area image.

According to one or more embodiments herein, the acquiring unit 501 may be adapted to acquiring the first image collected by the first image sensor of the binocular camera and the second image collected by the second image sensor of the binocular camera. The acquiring unit may be adapted to acquiring the first target area image and the second target area image by performing target detection respectively on the first image and the second image.

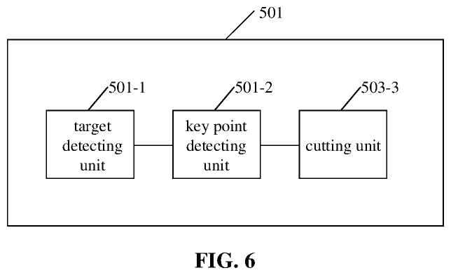

According to one or more embodiments herein, referring to FIG. 6, the acquiring unit 501 may include a target detecting unit 501-1, a key point detecting unit 501-2, and a cutting unit 501-3. The target detecting unit 501-1 may be adapted to acquiring a first candidate area by performing target detection on the first image collected by the first image sensor of the binocular camera. The key point detecting unit 501-2 may be adapted to acquiring key point information by performing key point detection on an image of the first candidate area. The cutting unit 501-3 may be adapted to cutting the first target area image from the first image according to the key point information.

According to one or more embodiments herein, the first target area image and the second target area image may be identical in size.

According to one or more embodiments herein, the first determining unit 502 may be adapted to acquiring the disparity between the first target area image and the second target area image by processing the first target area image and the second target area image using a binocular matching neural network.

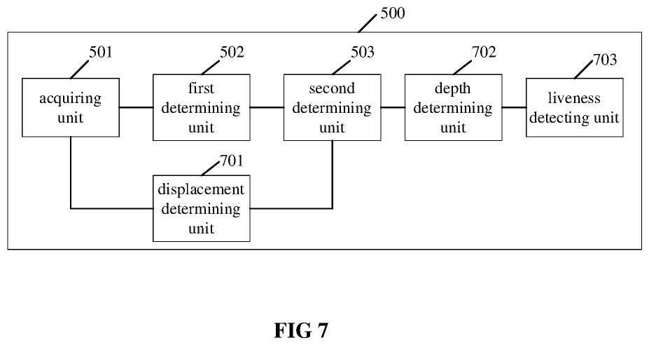

According to one or more embodiments herein, referring to FIG. 7, the device may further include a displacement determining unit 701. The displacement determining unit 701 may be adapted to, before the second determining unit 503 acquires the prediction result of the disparity between the first image and the second image based on the information on the displacement between the first target area image and the second target area image, as well as the disparity between the first target area image and the second target area image, determining the information on the displacement between the first target area image and the second target area image based on a location of the first target area image in the first image and a location of the second target area image in the second image.

According to one or more embodiments herein, the second determining unit 503 may be adapted to acquiring the prediction result of the disparity between the first image and the second image as a sum of the disparity between the first target area image and the second target area image, and the information on the displacement between the first target area image and the second target area image.

According to one or more embodiments herein, referring to FIG. 7, the device may further include a depth determining unit 702 and a liveness detecting unit 703. The depth determining unit 702 may be adapted to determining depth information of the target object based on the prediction result of the disparity between the first image and the second image between the first image and the second image acquired by the second determining unit 503. The liveness detecting unit 703 may be adapted to determining whether the target object is alive based on the depth information of the target object acquired by the depth determining unit 702.

According to one or more embodiments herein, the binocular camera may include a co-modal binocular camera or a cross-modal binocular camera.

According to one or more embodiments herein, the first image sensor or the second image sensor may include a visible light image sensor, a near infrared image sensor, a dual-channel image sensor, etc.

According to one or more embodiments herein, the target object may include a face.

A function or a module of the device here may serve to execute a method for processing an image herein. Refer to description of an aforementioned method for implementation of the device, which is not repeated here for simplicity.

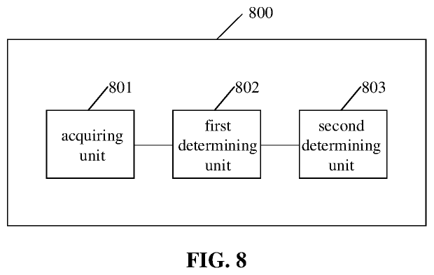

According to one or more embodiments herein, a device for processing an image is provided. FIG. 8 is a diagram of a structure of a device for processing an image according to an exemplary embodiment herein. The device 800 may include an acquiring unit 801, a first determining unit 802, and a second determining unit 803.

The acquiring unit 801 may be adapted to acquiring a first target area image of a target object and a second target area image of the target object. The first target area image is cut from a first image of an image collection area collected at a first time point. The second target area image is cut from a second image of the image collection area collected at a second time point.

The first determining unit 802 may be adapted to determining information on an optical flow between the first target area image and the second target area image by processing the first target area image and the second target area image.

The second determining unit 803 may be adapted to acquiring an optical flow prediction result between the first image and the second image based on information on a displacement between the first target area image and the second target area image, as well as the information on the optical flow between the first target area image and the second target area image.

According to one or more embodiments herein, the acquiring unit 801 may be adapted to acquiring the first image of the image collection area collected at the first time point and the second image of the image collection area collected at the second time point. The acquiring unit may be adapted to acquiring the first target area image and the second target area image by performing target detection respectively on the first image and the second image.

According to one or more embodiments herein, the acquiring unit 801 may include a target detecting unit, a key point detecting unit, and a cutting unit.

The target detecting unit may be adapted to acquiring a first candidate area by performing target detection on the first image of the image collection area collected at the first time point.

The key point detecting unit may be adapted to acquiring key point information by performing key point detection on an image of the first candidate area.

The cutting unit may be adapted to cutting the first target area image from the first image according to the key point information.

According to one or more embodiments herein, the first target area image and the second target area image may be identical in size.

According to one or more embodiments herein, the first determining unit 802 may be adapted to acquiring the information on the optical flow between the first target area image and the second target area image by processing the first target area image and the second target area image using a neural network.

According to one or more embodiments herein, the device may further include a displacement determining unit. The displacement determining unit may be adapted to, before the second determining unit 803 acquires the optical flow prediction result between the first image and the second image based on the information on the displacement between the first target area image and the second target area image, as well as the information on the optical flow between the first target area image and the second target area image, determining the information on the displacement between the first target area image and the second target area image based on a location of the first target area image in the first image and a location of the second target area image in the second image.

According to one or more embodiments herein, the second determining unit 803 may be adapted to acquiring the optical flow prediction result between the first image and the second image as a sum of the information on the optical flow between the first target area image and the second target area image and the information on the displacement between the first target area image and the second target area image.

The device for processing an image here may be applied to optical flow information prediction. A function or a module of the device here may serve to execute the method for processing an image in FIG. 4. Refer to description of the method for processing an image in FIG. 4 for implementation of the device, which is not repeated here for simplicity.

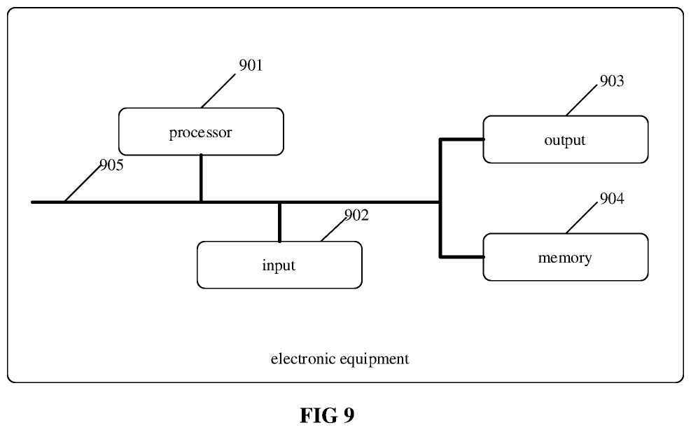

In addition, according to one or more embodiments herein, electronic equipment is provided. FIG. 9 is a block diagram of a structure of electronic equipment according to an exemplary embodiment herein. As shown in FIG. 9, the electronic equipment may include a processor 901 and memory 904. The memory may be adapted to storing an instruction executable by the processor. The processor 901 may be adapted to executing the method for processing an image herein as shown in FIG. 1 or any possible implementation thereof. Alternatively, the processor may be adapted to executing the method for processing an image herein as shown in FIG. 4 or any possible implementation thereof.

Optionally, the electronic equipment may further include one or more input equipment 902 and one or more output equipment 903.

The processor 901, the input equipment 902, the output equipment 903, and the memory 904 may be connected with each other through a bus 905. The memory 904 may be adapted to storing an instruction. The processor 901 may be adapted to executing the instruction stored in the memory 904. The processor 901 may be adapted to implementing, by calling the program instruction, the method for processing an image according to any embodiment herein, which is not repeated here for simplicity.

Note that the device herein has been described with the example of predicting a disparity. Optionally, a technical solution herein may be applied to optical flow prediction as well. Accordingly, a device for predicting an optical flow falls in the scope of the subject disclosure, too. A device for predicting an optical flow is similar to an aforementioned device for processing an image, and is not repeated here for simplicity.

Note that according to one or more embodiments herein, the processor 901 may be a Central Processing Unit (CPU). The processor may be another universal processor, a Digital Signal Processor (DSP), an Application Specific Integrated Circuit (ASIC), a Field-Programmable Gate Array (FPGA), another programmable logic device, a discrete gate or a transistor logic device, a discrete hardware component, etc. A universal processor may be a microprocessor or any conventional processor, etc.

The input equipment 902 may include a mobile phone, a desktop computer, a laptop, wearable equipment, a monitor image sensor, etc. The output equipment 903 may include a display, such as a Liquid Crystal Display (LCD), etc.

The memory 904 may include a Read-Only Memory (ROM), a Random Access Memory (RAM), etc. The memory may provide the processor 901 with an instruction, data, etc. A part of the memory 904 may further include a nonvolatile RAM. For example, the memory 904 may further store information on an equipment type.

Electronic equipment herein is adapted to executing an aforementioned method for processing an image. Accordingly, the processor 901 is adapted to executing a step and/or a flow in a method for processing an image according to one or more embodiments herein, which is not repeated here.

According to one or more embodiments herein, a computer-readable storage medium has stored thereon a computer program including program instructions which, when executed by a processor, implement a method for processing an image according to any embodiment herein, which is not repeated here for simplicity.

The computer-readable storage medium may be an internal storage unit of the electronic equipment according to any embodiment herein, such as a hard drive or memory of terminal equipment. The computer-readable storage medium may be external storage equipment of the terminal equipment, such as a plug-in hard drive, a Smart Media Card (SMC), a Secure Digital (SD) card, a flash card, etc., provided in the terminal equipment. Furthermore, the computer-readable storage medium may include both the internal storage unit of the electronic equipment and the external storage equipment. The computer-readable storage medium is adapted to storing the computer program and another program and data required by the electronic equipment. The computer-readable storage medium may further be adapted to temporarily storing data having been output or to be output.

A person having ordinary skill in the art may realize that a unit, an algorithm step, etc., disclosed herein may be implemented as electronic hardware, computer software, or a combination of the two. To clearly illustrate interchangeability of hardware and software, a composition, a step, etc., of an example have been illustrated generally in the description according to a function. Such a function may be implemented as hardware or software depending on application of a technical solution and a designed constraint thereto. A person of expertise may implement a described function depending on an application. Such implementation however shall not be deemed as going beyond the scope of the subject disclosure.

A person having ordinary skill in the art may clearly understand that one may refer to a corresponding process in an aforementioned method herein for operation of a server, equipment, a unit, etc., which may implement electronic equipment described herein, which is not repeated here.

Note that according to one or more embodiments herein, a server, equipment, a unit, etc., disclosed may be implemented in another manner. For example, the server herein may be but exemplary. For example, unit division may be done according to a logic function. Other division is possible in practice. For example, multiple units or components may be combined or integrated into another system, or some characteristics may be skipped or not executed. In addition, components coupled to each other or coupled directly, or in communication connection, as displayed or discussed, may be coupled or in communication connection indirectly through an interface, a device, a unit, etc., or may be connected electrically, mechanically, etc.

Units described as separate parts may or may not be physically separated. Parts displayed as units may or may not be physical units. They may be located in one place, or distributed over multiple network units. Some or all of the units may be selected to achieve the purpose of a solution herein as needed.

In addition, functional units in embodiments herein may be integrated in one processing unit. Each unit may exist separately physically. Two or more units may be integrated in one unit. Such an integrated unit may be implemented as hardware or a software functional unit.

When being implemented as a software functional unit and sold or used as an independent product, the integrated unit may be stored in a computer-readable storage medium. Based on such an understanding, an essential part of a technical solution herein that contributes to prior art, or all or part of the technical solution, may be embodied in form of a software product. The computer software product may be stored in a storage medium, including a plurality of instructions adapted to allowing computer equipment (which may be a personal computer, a server, network equipment, etc.) to implement all or part of the steps of a method herein. The storage medium may include various media capable of storing program codes, such as a U disk, a mobile hard drive, a Read-Only Memory (ROM), a Random Access Memory (RAM), a magnetic disk, a CD, etc.

What described are but embodiments herein and are not intended to limit the scope of the subject disclosure. Any modification, equivalent replacement, and/or the like made within the technical scope of the subject disclosure, as may occur to a person having ordinary skill in the art, shall be included in the scope of the subject disclosure. The scope of the subject disclosure thus should be determined by the claims.

1. A method for processing an image, comprising:
acquiring a first target area image of a target object and a second target area image of the target object, the first target area image being cut from a first image collected by a first image sensor of a binocular camera, the second target area image being cut from a second image collected by a second image sensor of the binocular camera;
determining a disparity between the first target area image and the second target area image by processing the first target area image and the second target area image; and
acquiring a prediction result of a disparity between the first image and the second image based on information on a displacement between the first target area image and the second target area image, as well as the disparity between the first target area image and the second target area image.

2. The method of claim 1, wherein acquiring the first target area image of the target object and the second target area image of the target object comprises:
acquiring the first image collected by the first image sensor of the binocular camera and the second image collected by the second image sensor of the binocular camera; and
acquiring the first target area image and the second target area image by performing target detection respectively on the first image and the second image.

3. The method of claim 1, wherein acquiring the first target area image of the target object comprises:
acquiring a first candidate area by performing target detection on the first image collected by the first image sensor of the binocular camera;
acquiring key point information by performing key point detection on an image of the first candidate area; and
cutting the first target area image from the first image according to the key point information.

4. The method of claim 1, wherein the first target area image and the second target area image are identical in size.

5. The method of claim 1, wherein determining the disparity between the first target area image and the second target area image by processing the first target area image and the second target area image comprises:
acquiring the disparity between the first target area image and the second target area image by processing the first target area image and the second target area image using a binocular matching neural network.

6. The method of claim 1, further comprising: before acquiring the prediction result of the disparity between the first image and the second image based on the information on the displacement between the first target area image and the second target area image as well as the disparity between the first target area image and the second target area image,
determining the information on the displacement between the first target area image and the second target area image based on a location of the first target area image in the first image and a location of the second target area image in the second image.

7. The method of claim 1, wherein acquiring the prediction result of the disparity between the first image and the second image based on the information on the displacement between the first target area image and the second target area image as well as the disparity between the first target area image and the second target area image comprises:
acquiring the prediction result of a disparity between the first image and the second image as a sum of the disparity between the first target area image and the second target area image and the information on the displacement between the first target area image and the second target area image.

8. The method of claim 1, further comprising:
determining depth information of the target object based on the prediction result of the disparity between the first image and the second image; and
determining whether the target object is alive based on the depth information of the target object.

9. The method of claim 1, wherein the binocular camera comprises a co-modal binocular camera or a cross-modal binocular camera.

10. The method of claim 1, wherein the first image sensor or the second image sensor comprises a visible light image sensor, a near infrared image sensor, or a dual-channel image sensor.

11. (canceled)

12. A method for processing an image, comprising:
acquiring a first target area image of a target object and a second target area image of the target object, the first target area image being cut from a first image of an image collection area collected at a first time point, the second target area image being cut from a second image of the image collection area collected at a second time point;
determining information on an optical flow between the first target area image and the second target area image by processing the first target area image and the second target area image; and
acquiring an optical flow prediction result between the first image and the second image based on information on a displacement between the first target area image and the second target area image, as well as the information on the optical flow between the first target area image and the second target area image.

13. The method of claim 12, wherein acquiring the first target area image of the target object and the second target area image of the target object comprises:
acquiring the first image of the image collection area collected at the first time point and the second image of the image collection area collected at the second time point; and
acquiring the first target area image and the second target area image by performing target detection respectively on the first image and the second image.

14. The method of claim 12, wherein acquiring the first target area image of the target object comprises:
acquiring a first candidate area by performing target detection on the first image of the image collection area collected at the first time point;
acquiring key point information by performing key point detection on an image of the first candidate area; and
cutting the first target area image from the first image according to the key point information.

15. (canceled)

16. The method of claim 12, wherein determining the information on the optical flow between the first target area image and the second target area image by processing the first target area image and the second target area image comprises:
acquiring the information on the optical flow between the first target area image and the second target area image by processing the first target area image and the second target area image using a neural network.

17. The method of claim 12, further comprising: before acquiring the optical flow prediction result between the first image and the second image based on the information on the displacement between the first target area image and the second target area image, as well as the information on the optical flow between the first target area image and the second target area image,
determining the information on the displacement between the first target area image and the second target area image based on a location of the first target area image in the first image and a location of the second target area image in the second image.

18. The method of claim 12, wherein acquiring the optical flow prediction result between the first image and the second image based on the information on the displacement between the first target area image and the second target area image, as well as the information on the optical flow between the first target area image and the second target area image comprises:
acquiring the optical flow prediction result between the first image and the second image as a sum of the information on the optical flow between the first target area image and the second target area image and the information on the displacement between the first target area image and the second target area image.

19.-36. (canceled)

37. Electronic equipment, comprising a processor and memory,
wherein the memory is adapted to storing a computer-readable instruction,
wherein the processor is adapted to implementing, by calling the computer-readable instruction stored in the memory:
acquiring a first target area image of a target object and a second target area image of the target object, the first target area image being cut from a first image collected by a first image sensor of a binocular camera, the second target area image being cut from a second image collected by a second image sensor of the binocular camera;
determining a disparity between the first target area image and the second target area image by processing the first target area image and the second target area image; and
acquiring a prediction result of a disparity between the first image and the second image based on information on a displacement between the first target area image and the second target area image, as well as the disparity between the first target area image and the second target area image.

38. A computer-readable storage medium, having stored therein computer program instructions which, when executed by a processor, implement the method of claim 1.

39. (canceled)

40. Electronic equipment, comprising a processor and memory,
wherein the memory is adapted to storing a computer-readable instruction,
wherein the processor is adapted to implementing, by calling the computer-readable instruction stored in the memory, the method of claim 12.

41. A computer-readable storage medium, having stored therein computer program instructions which, when executed by a processor, implement the method of claim 12.
